(19) United States
(12) Patent Application Publication
(10) Pub. No.: US 2026/0175940 A1
(43) Pub. Date: Jun. 25, 2026

(54) BRAKE COMPONENT WITH A HAND-OPERATED BRAKE LEVER FOR OPERATING A BRAKE CYLINDER

(71) Applicant: TRICKSTUFF GMBH, Pfaffenweiler (DE)

(72) Inventors: Santé Miguel PELOT, Freiburg (DE); Gurvan GUÉHENNEUC, Fessenheim (FR); Martin HOLM, Freiburg (DE)

(21) Appl. No.: 19/423,641

(22) Filed: Dec. 17, 2025

(30) Foreign Application Priority Data
Dec. 23, 2024 (DE) 10 2024 139 659.8

(51) Int. Cl. B62L 3/02

(52) U.S. Cl. CPC B62L 3/023

(57) ABSTRACT

A brake component with a brake lever for actuating a handbrake, wherein the lever includes a lever body extending longitudinally with a lever element for manually applying operational pressure to the brake lever. A proximal part of the lever element has a bearing point and a distal part of the lever element is manually subjected to tensile force by the user to cause a braking effect by a pivot movement about a bearing point pivot axis. A transversely extending hollow chamber structure is formed in the lever body adjacent the bearing point, to provide a predetermined breaking point of the lever element adjacent the hollow chamber structure so that upon impact, the lever element breaks at this predetermined breaking point. A second bearing point is formed on the lever body adjacent to the first bearing point. The hollow chamber structure is formed between the first and second bearing point.

### BACKGROUND

The present invention relates to a brake component with a hand-operated or hand-operable brake lever for actuating a handbrake and, in particular, a brake cylinder, preferably, a brake cylinder of a hydraulic brake, in particular, of a bicycle or a motorcycle or the like as well as a braking device, in particular, hydraulically operated braking device, in particular, of a bicycle or motorcycle or the like as well as a method for producing a brake lever, wherein the brake lever has a lever element for manually applying tensile or compressive loads to the lever element in order to trigger a braking effect of the brake cylinder. The invention can also relate to another lever on a handlebar of a bicycle, such as a lever for the gear shift, suspension or for adjusting the seat post, in particular, of a bicycle.

Hand-operated brake levers for actuating a brake cylinder have become known in the prior art.

In the event of an accident, a brake lever should not break in such a way that it becomes dangerous. Such brake levers, in particular, for example on mountain bikes or motorcycles, which can break off in the event of an impact, usually at the thinnest point of the brake lever, are known from the prior art. A relatively long piece usually remains on the pump housing. This has the advantage that the brake lever often remains operable in an emergency. The rider can continue to use the remaining lever as a brake with one, two or more fingers. However, the disadvantage is that a broken lever often has a sharp end. The risk of injury to the hand is high if the user continues to ride with a dangerously sharp lever end.

Based on this, one object is therefore to offer, in a cost-effective manner, a brake component with a hand-operated or hand-operable brake lever for bicycles, motorcycles or the like, where a risk of injury (to the hand) of the user is considerably reduced in the event of an accident.

### SUMMARY

A brake component according to the invention comprises a hand-operated brake lever for operating and/or actuating a handbrake, in particular, of a bicycle or a motorcycle or the like. The brake lever comprises at least one lever body extending in a longitudinal direction with a lever element formed thereat and/or thereon for manually applying pressure (tensile or compressive loads) to the brake lever in order to trigger a braking effect (via, in particular, a brake cylinder or, if applicable a Bowden cable), wherein a proximal part of the lever element has (comprises) at least one bearing point, and wherein a distal part of the lever element is designed and provided to be manually subjected to tensile force by the user (in a load direction) in order to cause a braking effect (of the handbrake) by a pivot movement (of the lever body) about a pivot axis of the bearing point and, in particular, to actuate a brake cylinder to produce a braking effect.

According to the invention, a hollow chamber structure extending transverse to the longitudinal direction of the lever element and transverse to the pivot axis in a transverse direction is formed in the lever body adjacent to the bearing point, in order to provide or produce a predetermined breaking point of the lever element (on or in the lever element) in the region of the hollow chamber structure so that in the event of an impact, the lever element breaks at this predefined proximally arranged predetermined breaking point (and preferably only or primary at this predetermined breaking point). In particular, a second bearing point is formed on the lever body adjacent to the first bearing point and the hollow chamber structure is preferably formed between the first and second bearing point.

According to the invention, a risk of injury to the user can be reduced. In particular, this can prevent an injury to the user (and, in particular, at least the hand of the user) from a broken-off piece of the lever element that remains in an unfavourable position.

The invention has many advantages. One significant advantage is that the brake component proposed here allows the brake lever to break off as short as possible in the event of a breakage, in order to prevent an or even any injury (to the hand) of the user. The breakage is precisely defined by the predetermined breaking point. This is achieved through the design of the hollow chamber structure and an associated wall thinning or wall thickness shaping. The brake lever or at least the lever element is therefore at least partially hollow. The wall of the lever element of the brake lever is, in particular, designed in the form of a cavity wall.

It is therefore reliably prevented that the lever part remaining on the brake component has a long sharp end. The brake lever breaks close to a brake unit and, for example, close to the pump housing. The risk of injury to the hand is quite considerably reduced.

It is also very advantageous that it prevents a user from continuing to ride with a dangerously sharp lever end. The remaining lever end is not long enough for the user to be able to operate the brake with two or three fingers. Usually, they cannot operate the brake lever with a single finger after breakage. The distal part may remain connected to the pump housing if applicable, but no pressure can be applied. The remaining piece is freely moveable or breaks off.

Breakage at a thin point far away from the pump housing is prevented. Long, sharp edges are not created during breakage, which could cause even more serious injury to the hand of the rider.

For brake levers whose attachment point is narrower than the attachment points of the pump housing, it is not strictly necessary to additionally thin out the brake lever as the brake lever is already relatively narrow at the attachment point compared to the finger surface.

The invention enables the brake lever to break off in the event of an impact and the part attached thereto to be as short as possible in order to prevent injuries. As a result, the design of the (still fully functional) product is also impacted as little as possible. A remaining length of 1 or at most 2 mm is realistic.

Such a breakage also prevents the user from failing to bring the bicycle in for repair or doing so very late. It prevents the misconception that sufficient braking force can actually be produced with the remaining length of the brake lever. This prevents the risk of touching sharp edges with the hand. Such sharp edges can even cut through gloves. Avoiding such problems not only prevents a risk to the rider but also increases overall traffic safety.

A significant advantage of the design of the hollow chamber structure is that a local reduction in the area moments of inertia in the transverse direction (usually the direction from top to bottom when installed as intended) can also be achieved in combination with the hollow wall design. A combination of the reduction of area moments of inertia combined with a hollow wall design can therefore not only define the predetermined breaking point more clearly.

Synergy effects also arise independently of one other. A reduction of area moments of inertia can result in a predetermined breaking point in the immediate vicinity of the attachment points when the lever is loaded in the transverse direction to the load during braking, such as in the event of an accident.

The invention is a mechanical safety device for a brake lever in the transverse direction (transverse or perpendicular to the usual load direction during braking; perpendicular to the plane in which the brake lever is pivoted during braking), which causes the lever to bend or break in a certain region, wherein the mechanical safety device is preferably not located in the region of the smallest height (distance between the outermost edges in the transverse direction) along the brake lever.

A bearing point can be designed as a bearing seat. The bearing point can comprise a bearing hole and a wall surrounding the bearing hole. In any case, the bearing point defines a pivot axis. The lever body or lever element can be pivoted about this pivot axis. A separate bearing such as a roller bearing or plain bearing or the like can be accommodated or formed at the bearing point in order to enable low-friction pivoting. It is also conceivable in simple embodiments that the bearing point is formed directly in the lever body (and, in particular, has no rolling elements and comprises no bearing or plain bearing).

The brake lever can be produced by 3D printing, but could also be achieved by casting or moulding. One focus of this invention is on a 3D-printed lever, but in the case of a lever made of fibre composites (carbon fibre, etc.), the objective could also be achieved with the layup (i.e. via the number of layers and the layer arrangement).

In preferred embodiments, the hollow chamber structure comprises a plurality of adjacent hollow chambers (separate from one another). Preferably (thin) walls are then formed between the individual hollow chambers. The hollow chambers can be formed as cavities and also referred to as such (cavities) alternatively to the term hollow chamber.

At least one hollow chamber is preferably designed as a recess and is open at at least one end to the environment. A hollow chamber is regularly filled with, for example, air (ambient air) or another material. If a (solid) material is used, the hollow chamber is in principle preferably filled with a lighter material than the material of the lever body. For example with a foam or a plastic or the like.

In preferred embodiments, the hollow chambers are designed as through holes, which extend from one to the opposite surface on the lever body. In particular, hollow chambers also visible in the installed state. It is also possible to close the hollow chambers with a cover or tape or the like. Individual and, in particular, most or all hollow chambers of the hollow chamber structure are particularly preferably respectively surrounded by a wall (all around or completely).

In advantageous embodiments, at least one wall around a hollow chamber has a notch (for producing or strengthening the effect of the predetermined breaking point). This contributes to the function of the predetermined breaking point.

The hollow chamber structure is preferably considerably longer in the transverse direction (of the lever body) than it is wide in the longitudinal direction (of the lever body) and/or thick along the pivot axis. The hollow chamber structure is preferably longer than it is wide and/or thick by at least a factor or 2 or 3 or 4.

It is advantageous if the hollow chamber structure extends over more than ⅔ or more than 70% or more than 75% or 80% or 90% or more of a width of the lever body.

The hollow chamber structure can have a honeycomb structure and/or lattice structure, in which the walls between the hollow chambers form the honeycomb structure.

In particular, a maximum extension of a hollow chamber in a plane defined by the transverse direction and the longitudinal direction (or a plane parallel to the surface of the lever body; the transverse direction and the longitudinal direction lie in or parallel to the pivot plane of the brake lever during “normal” braking) is smaller than ⅓ or ¼ or ⅕ or ⅙ or ⅛ of a width of the lever body in the region of the hollow chamber structure. This means that the hollow chamber structure has a plurality of 3, 4, 5, 6 or a multitude of small or thin hollow chambers or recesses.

In particularly preferred embodiments, a second bearing point is formed on the lever body adjacent to the (first) bearing point. The hollow chamber structure is then, in particular, formed between the first and the second bearing point. An intermediate space between the two bearing points in the longitudinal direction is preferably smaller than a width of the lever body between the bearing points and in particular also smaller than a diameter or radius of a bearing point.

It is possible and preferred that a second hollow chamber structure is formed on the lever body. The second hollow chamber structure can, in particular, be formed on the same section of the lever body. The second hollow chamber structure can be present on the same fork branch if the lever body has, for example, two fork branches. A second hollow chamber structure is preferably formed adjacent to the second bearing point. A hollow chamber structure is then preferably respectively provided on both sides of the second bearing point.

It is preferred that the lever body has at least one pair of bearing points arranged one above the other in alignment along the pivot axis, to which a pair of hollow chamber structures is assigned.

According to at least one embodiment, the distal part of the brake lever (then) runs in a fork-like manner in the direction of the proximal part of the brake lever, and thus forms (at least) two fork branches arranged one above the other. The fork branches are preferably congruent and/or mirror-symmetrical. The pair of aligned bearing points or bearing holes is formed on the fork branches.

It is possible and preferred that a second pair of bearing points arranged one above the other in alignment is (also) formed or comprised on the two fork branches running one above the other. It is then preferred that the hollow chamber structure is formed as a predetermined breaking point between the first pair and the second pair of bearing points (respectively). Such a predetermined breaking point enables reliable function and a high degree of safety.

According to at least one preferred embodiment, at least one hollow chamber or cavity is free of an inner support structure such that breakage at the predefined predetermined breaking point can be achieved in a targeted manner.

The fact that the hollow chamber or cavity is free of an internal support structure prevents a predetermined breaking point from being altered by the non-existent support structure. A formation and initiation of the predetermined breaking point can be reliably defined precisely due to the absence of any support structure within the cavities, i.e. cross struts within the individual cavities etc.

According to at least one embodiment, thanks to the targeted formation of the hollow chamber structure and/or thanks to a targeted formation of at least another cavity or another hollow chamber structure on or within the brake lever, in the event of an impact at least one subsequent predetermined breaking point and/or an alternative or other predetermined breaking point is formed on the brake lever. This alternative, further or other predetermined breaking point is, in particular, designed and provided to break if (at least) one (defined) other load or a defined other load case occurs. The one hollow chamber structure is designed, in particular, for a (first) load case and provides a (or a first) predetermined breaking point. The other hollow chamber structure is designed, in particular, for another or second load case and provides another (or a second) predetermined breaking point. The (primary) force or load acting in the second load case is, in particular, oriented transverse (or perpendicular) to a (primary) force or load acting in the first load case. It is also possible that a cascade of predetermined breaking points is provided.

According to at least one embodiment, the breaking points are formed on various bearing points or branches and/or on various forks (also referred to as fork element or brake lever fork element) such that injury (to the hand) of the user on a remainder of the lever element is prevented.

One or more area moments of inertia of the fork branches are preferably set in the horizontal and/or vertical direction so that the predetermined breaking point and preferably also the subsequent predetermined breaking point can be formed in a predefined manner.

In particular, the hollow chamber structure has at least two or more hollow chambers or cavities separated from one another by a wall, which are respectively designed in the same manner as the first cavity, wherein the cavities are, in particular, also free of inner support structures.

The hollow chamber structure can form a lattice structure in the horizontal direction between the bearing holes within at least one fork branch at least in places by means of the lever material, wherein at least one of the lattice bars of the lattice structure forms the predetermined breaking point or another predetermined breaking point.

In preferred embodiments, at least in some places, preferably proximally, for example between two bearing holes, in particular, a border of a bearing wall of at least one bearing hole, an indentation is produced to create the predetermined breaking point or another predetermined breaking point.

According to at least one embodiment, the lever element and, in particular, the brake lever is formed integrally (and thus free of gaps and grooves) and is produced by means of a 3D printing method such that the hollow chamber structure is also printed by or results from successive layer build-up.

In particular, the brake lever or lever element is formed integrally with a plastic. The plastic is preferably fibre-reinforced.

According to at least one embodiment, the brake component and, in particular, the brake lever is formed at least in places with a metal or metal composite material and forms a brake lever for a bicycle or motorcycle, which is attached to the handlebar.

According to at least one embodiment, the brake component comprises a brake unit such as a hydraulic brake cylinder. The brake component can be designed as a braking device and, in particular, as a hydraulically operated braking device. The braking device is provided, in particular, for use on a bicycle (or a motorcycle or the like) and comprises a brake lever, as described above. The brake lever preferably actuates a brake hydraulic system by means of rotation about at least one bearing hole.

The applicant reserves the right to claim a (further) bicycle operating lever (separately). Such a bicycle operating lever comprises a hand-operated operating lever for actuating (operating) a bicycle component such as a derailleur, a seatpost, a suspension element and a damping element, wherein the operating lever comprises a lever body extending in a longitudinal direction with a lever element formed thereon for manually applying pressure to the operating lever in order to change a setting or trigger an effect, wherein a proximal part of the lever element has at least one bearing point, and wherein a distal part of the lever element is designed and provided to be manually subjected to tensile force by the user in order to change a setting or trigger an effect by a pivot movement about a pivot axis of the bearing point. A hollow chamber structure extending in a transverse direction is formed in the lever body adjacent to the bearing point, and runs transverse to the longitudinal direction of the lever element and transverse to the pivot axis in order to provide a predetermined breaking point of the lever element in the region of the hollow chamber structure so that in the event of an impact, the lever element breaks at this predefined proximally arranged predetermined breaking point. A clutch lever could also be provided in a correspondingly adapted manner.

The bicycle according to the invention comprises a frame, at least two wheels and a handlebar and at least one brake component in a design or embodiment described above. The brake lever of at least one brake component is, in particular, attached to the handlebar.

A method for which the applicant reserves the right to seek protection is used, in particular, to produce a brake component described above and, in particular, a brake lever and particularly preferably a brake lever of a hydraulically operated manual braking device, wherein at least one brake element or the brake lever overall is printed, in particular, layer for layer by means of a 3D printing device. In particular, in order to avoid airborne dust pollution caused by the printing medium during printing, for example a material in dust form, suction openings are formed in the brake lever itself during printing, through which the printing medium is sucked out such that dust pollution is minimised. A plastic can be used as material. A light metal is preferably printed. Particularly preferably titanium or a titanium-based material. In particular, at least one bearing point for providing a pivot axis is formed during printing. A hollow chamber structure (having a plurality of hollow chambers separated from one another) is formed adjacent to the bearing point in order to provide a predetermined breaking point of the lever element in the region of the hollow chamber structure so that in the event of an impact, the lever element breaks at this predefined predetermined breaking point.

A plurality of adjacent grooves running around the pivot axis are preferably formed at the bearing point. This reduces the weight. In particular, the tolerances for the installation of a bearing are increased as a result. If, for example, a roller bearing is installed, tight tolerances are usually advisable.

However, the tolerances achievable on the finished product using 3D printing are generally poorer than with other manufacturing methods. The tolerance could be reduced further (and the fit improved) by finish-machining. But that is time-consuming. It is more advantageous if a structure is provided by the circumferential grooves that reduces the requirements for the necessary tolerances. Due to the fact that a “wave-shaped” structure is created on the inner wall of the bearing point (parallel to the axis of rotation), (slight) local deformation can be achieved when installing a bearing, thereby reducing the manufacturing precision required. In a sense, local compensation of the material or local compression and decompression takes place in the (usually hard) material of the bearing shell or in the surrounding wall of the lever element. This is, in particular, advantageous for an operating lever or brake lever which is produced using 3D printing.

Further advantages and features of the present invention result from the exemplary embodiments which are outlined below with reference to the appended figures.

### BRIEF DESCRIPTION OF THE DRAWINGS

### In the Figures:

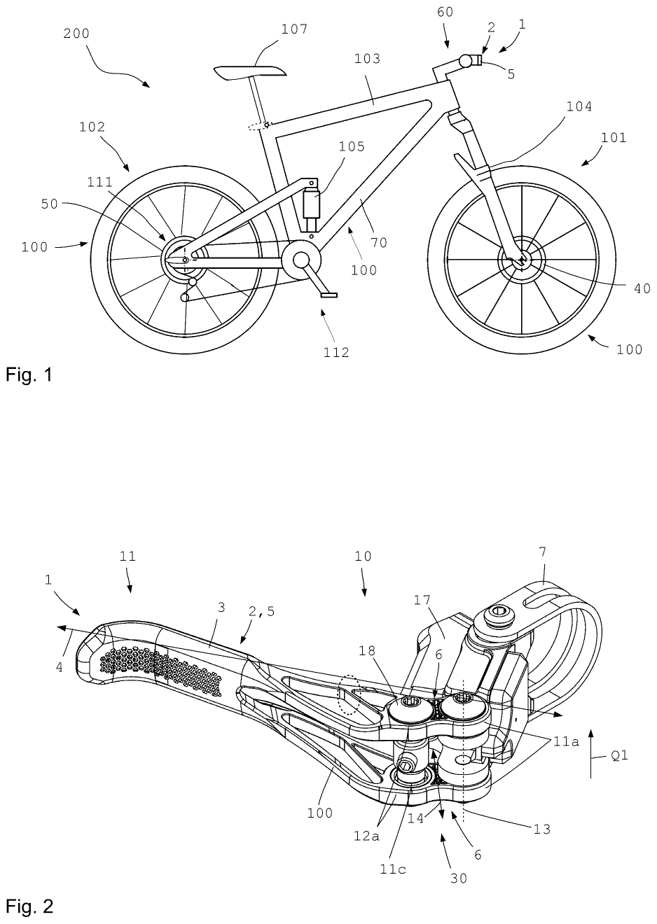

FIG. 1 shows a schematic illustration of a mountain bike having brake components according to the invention;

FIG. 2 shows a brake component according to the invention in a perspective view;

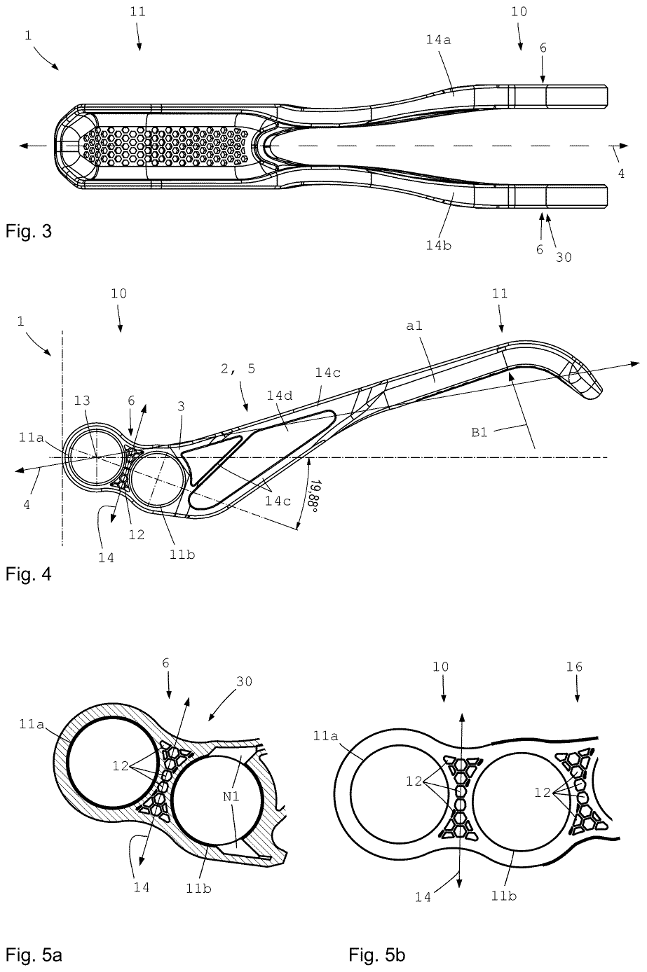

FIGS. 3, 4 show detail views of brake components according to the invention;

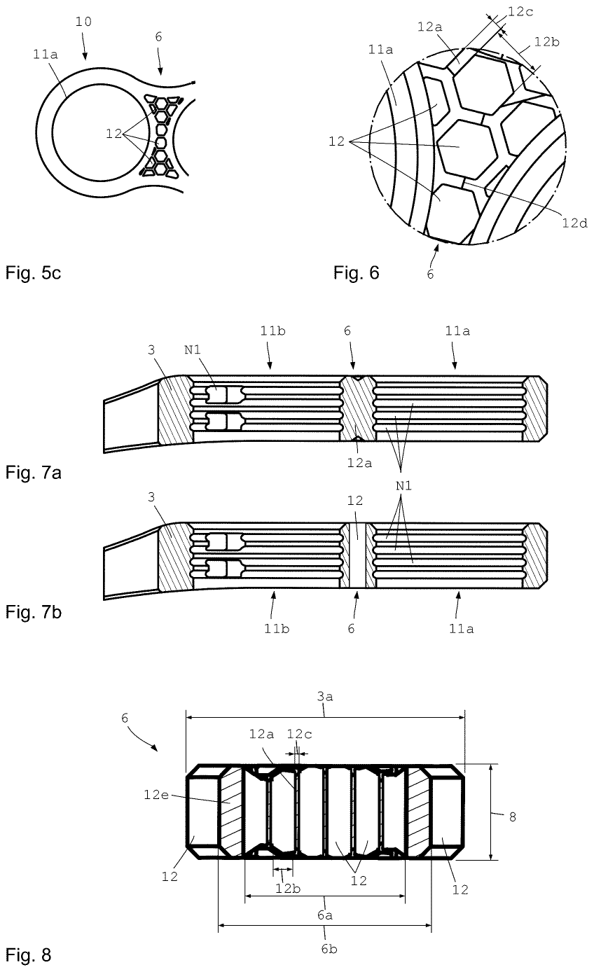

FIGS. 5a-5c show enlarged detail views of brake components according to the invention;

FIG. 6 shows an enlarged detail view of a hollow chamber structure in a plan view;

FIGS. 7a-7b show enlarged sectional views of a brake component according to the invention; and

FIG. 8 shows a cross-section through a brake component according to the invention.

### DETAILED DESCRIPTION

FIG. 1 shows a bicycle 200, which respectively has hand-operated brake levers 2. The mountain bike or gravel bike 200 has a handlebar 60, a front wheel 101 and a rear wheel 102, which respectively have bicycle rims 50. The brake levers 2 are attached to the handlebar via fastening clamps 7 (cf. FIG. 2).

A pinion device 111 is present on the rear wheel 102. Both wheels 101, 102 respectively have wheel spokes 109. Conventional rim brakes or other brakes such as disc brakes may be provided.

A bicycle 200 has a frame 103, which comprises frame components 70. The bicycle 200 has a saddle 107, a bicycle fork 104 and in the case of a mountain bike a rear wheel damper 105 may be provided. A pedal crank 112 with pedals is used for drive. An electric auxiliary drive may optionally be provided on the pedal crank 112 and/or wheels.

FIG. 2 shows an exemplary embodiment of a brake component 1 according to the invention with a hand-operated brake lever 2 for actuating or operating a brake cylinder 17, preferably a brake cylinder of a hydraulic brake. The brake component 1 is provided for use on a bicycle 200 or a motorcycle or the like. The brake component 1 can be offered as a set and also comprise a brake calliper, a brake disc and the hydraulic lines.

The brake lever 2 comprises a lever element 5 with a lever body 3 for manually applying tensile or compressive loads to the lever element 5 in order to trigger a braking effect of the brake cylinder 17. A proximal part 10 of the lever element 5 has two pairs of bearing points 11a, 11b here, which are arranged above one another in the transverse load direction Q1, with bearing holes, on which bearings 11c are accommodated here. A distal part 11 of the lever element 5 is designed and provided to be manually subjected to tensile force by the user in order to actuate the brake cylinder to produce a braking effect. The lever body 3 extends here in a longitudinal direction 4. The lever body 3 is slightly curved in an S-shape here, but can in principle also be straight or have another design.

FIG. 2 shows that the lever element 5 has at least one hollow chamber structure 6 with a plurality of hollow chambers or cavities 12 (cf. FIG. 4) in order to provide a predetermined breaking point 30 of the lever element (on or in the lever element) 5 in the region of the hollow chamber structure 6 so that in the event of an impact, the lever element 5 breaks at this predefined proximally arranged predetermined breaking point 30 and preferably only at this predetermined breaking point 30. Injury to the hand of the user from a remaining broken-off piece of the lever element 5 is thus largely prevented.

The lever element 5 can be pivoted about the pivot axis 13, which is defined by the bearing point 11a. Adjacent to the bearing point 11a, the hollow chamber structure 6, which has a plurality of hollow chambers 12, extends transverse to the longitudinal direction 4 in the transverse direction 14. Walls 12a surround the bearings 11c and hollow chambers 12.

The brake lever 2 is secured to the brake component 1 via attachment elements 18.

FIG. 3 shows an embodiment of the brake component 1 in a front view. The brake component 1 has a brake lever 2 or a brake element 5, which has a lever body 3.

The brake lever 2 is fork-like here and extends from a proximal end 10 to a distal end 11. The lever body 3 runs from the distal end 11 initially integrally and separates in a fork-like manner into two (integrally connected) fork branches 14a, 14b, which run parallel to one another up to the proximal end 10. At least one bearing point 11a is formed in the two fork branches 14a, 14b in the vicinity of the proximal end 10. Adjacent and, in particular, directly adjacent thereto, a hollow chamber structure 6 is respectively formed, which defines a predetermined breaking point 30 (in both branches) if considerable forces act on the brake lever 2 in the transverse load direction Q1 (cf. FIG. 2) during a fall.

In other embodiments, it is also possible that the brake lever 2 is not fork-like and only has a single fork branch.

FIG. 4 shows a brake lever 2 in a side view. This brake lever could have only one fork branch 14a, but can also have two fork branches and then corresponds to the embodiment according to FIG. 3. In principle, the function according to the invention can be achieved with both variants.

It can clearly be seen that two adjacent bearing points 11a, 11b are formed at the proximal end. At the bearing point 11a, the brake lever is mounted so as to be pivotable about the pivot axis 13. An articulated connection, for example of a hydraulic cylinder 17, is provided at the bearing point 11b (cf. FIG. 2).

The hollow chamber structure 6 is formed here between the bearing points 11a and 11b and extends in a transverse direction 14 transverse to the longitudinal direction 4. The transverse direction 14 can be oriented perpendicular to the longitudinal direction, but is often not, as this exemplary embodiment also shows.

As shown in FIG. 4, the hollow chamber structure 6 has a plurality of adjacent hollow chambers 12, which are arranged in a row in the transverse direction 14.

The lever body 3 can have webs 14c and free spaces 14d in order to enable a small weight. The thin webs could result in injuries to the user if the brake lever breaks sharply there during a fall. This is reliably and largely prevented by the hollow chamber structure 6, which provides a predetermined breaking point 30. The protruding end of the lever body is then cut off, and a risk of injury is significantly reduced.

FIGS. 5a, 5b and 5c show three design variants in a respectively enlarged detail view.

FIG. 5a shows, in principle, the embodiment according to FIG. 4 in an enlarged view, wherein the individual hollow chambers of the hollow chamber structure 6, which are also visible during operation, are clearly visible and extend substantially along the transverse direction 14 across the width of the lever body 3. The hollow chamber structure 6 is formed between the bearing points 11a and 11b. Recesses or grooves N1 are visible at the bearing point 11b. These reduce the weight. Another significant advantage of the recesses or grooves N1 is that the tolerances in production can be set (somewhat) more generously, which is particularly advantageous during production with a 3D printing method. The grooves can be annular or spiral in the form of a thread in all embodiments. A plurality are preferably formed adjacently. For example three, four, five, six or seven. There can also be more or fewer.

FIG. 5b shows a variant where a (first) hollow chamber structure 6 is formed between the bearing points 11a and 11b and forms a predetermined breaking point 30. Adjacent to the second bearing point 11b, another or second hollow chamber structure 16 is provided, which provides another predetermined breaking point such that a cascade of predetermined breaking points is provided here. A corresponding embodiment can influence whether the lever body 3 initially breaks at the one or other predetermined breaking point.

FIG. 5c shows a variant where only one bearing point 11a is provided. This can, for example, be the case if the lever body 3 presses on another component or pulls on a Bowden cable or the like.

In all embodiments, it is possible that the lever body 3 is fork-like or not fork-like.

FIG. 6 shows an enlarged illustration of a hollow chamber structure 6 (or 16) in a plan view, wherein (at least) one bearing point 11a is shown here. The hollow chamber structure 6 comprises a plurality of adjacent hollow chambers 12 or cavities, which extend fully through the lever body 3 here in the direction of the pivot axis and can be designed to be open (or closed) at both ends. An open design results in visibility and can enhance the feeling of security.

The individual hollow chambers 12 can, for example, have a hexagonal or honeycomb-shaped cross-section and are separated from one another by (thin) walls 12c. A (typical or for example maximum) diameter 12b of a hollow chamber 12 is, in particular, between twice and eight times as large as a wall thickness 12c. The walls 12a can (partly) have indentations 12d in order to enhance the effect.

FIGS. 7a and 7b schematically show minimally different cross-sections through a lever body 3 with respectively two bearing points 11a, 11b and a hollow chamber structure 6 respectively arranged therebetween as a predetermined breaking point 30. A wall 12a is shown in FIG. 7a centrally between the two bearing points 11a, 11b. The schematic cross-section according to FIG. 7b, cut slightly off-centre or at a different angle shows a hollow chamber 12 in the centre, which is part of the hollow chamber structure 6.

In order to reduce the weight and improve the function of the predetermined breaking point, grooves N1 are formed in the bearing points 11a, 11b, which help to combine the forces that occur.

FIG. 8 shows a cross-section in the transverse direction 14 through a lever body 3 along a hollow chamber structure. It shows hollow chambers 12, which are separated from one another by thin walls 12a. A ratio of the respective extension or maximum extension 12b of the hollow chambers to a wall thickness 12c is greater here than 3 and, in particular, greater than 4 and preferably smaller than “8”. This means that a plurality of small hollow chambers are present adjacent to one another.

The thickness 8 along the pivot axis 13 is at least twice as large as a(n) (maximum) extension 12b. An inner width 6a of the hollow chamber structure is preferably at least half as large as a maximum outer width 3a. Alongside the outer walls 12e, which are thicker compared to the walls 12a between two hollow chambers 12, hollow chambers or recesses 12 can also be formed on the outside.

A predetermined breaking point 30 is preferably arranged particularly close to the bearing points or bearing holes 11a, 11b.

The hollow chambers 12 are, in particular, free of any support structures.

As shown in the figures, there are also further features that may be caused, in particular, by the 3D printing of the brake lever 2 or are useful for it, namely the removal of excess powder. Powder is the raw material for 3D printing and can be harmful for breathing. It is therefore advisable to provide sufficient openings for removing powder from the hollow regions during production. It is desirable for these openings to be invisible from the outside. These openings should also be arranged such that they are at the deepest possible point when the brake lever 2 is being printed in order to minimise the amount of powder that accumulates in the hollow regions. It is also desirable to have a second opening, which enables the use of, for example, compressed air in order to force the remaining powder out of the cavities. The upper opening can, for example, be used as an inlet for compressed air.

While a particular embodiment of the present brake component with a hand-operated brake lever for operating a brake cylinder have been described herein, it will be appreciated by those skilled in the art that changes and modifications may be made thereto without departing from the invention in its broader aspects and as set forth in the following claims.

### REFERENCE LIST

1 brake component
2 brake lever
3 lever body
3a width
4 longitudinal direction
5 lever element
6 hollow chamber structure
6a inner width
6b outer width
7 fastening clamp
8 thickness
10 proximal part
11 distal part
11a,11b bearing points, bearing seats, bearing holes
11c bearing
12 hollow chamber, cavity, recess
12a wall
12b extension
12c wall thickness
12d indentation
12e outer wall
13 pivot axis
14 transverse direction
14a fork branch
14b fork branch
14c web
14d free space
15 inner surface
16 hollow chamber structure
17 brake unit, brake cylinder
18 attachment element
20 suction openings
30 predetermined breaking point
40 brake disc
B1 load direction
Q1 transverse load direction
N1 recess/groove
101 wheel, front wheel
102 wheel, rear wheel
103 frame
104 bicycle fork
105 rear wheel damper
107 saddle
109 wheel spokes
111 pinion device
112 pedal crank
200 bicycle

1. A brake component with a hand-operated brake lever for actuating a handbrake in particular of a bicycle or a motorcycle or the like, wherein the brake lever comprises: a lever body extending in a longitudinal direction with a lever element formed thereon for manually applying pressure to the brake lever in order to trigger a braking effect; wherein a proximal part of the lever element comprises at least one bearing point;
and wherein a distal part of the lever element is designed and provided to be manually subjected to tensile force by the user in order to cause a braking effect by a pivot movement about a pivot axis of the bearing point;
a hollow chamber structure extending in a transverse direction is formed in the lever body adjacent to the bearing point, runs transverse to the longitudinal direction of the lever element and transverse to the pivot axis in order to provide a predetermined breaking point of the lever element in the region of the hollow chamber structure so that in the event of an impact, the lever element breaks at this predefined proximally arranged predetermined breaking point;
and a second bearing point is formed on the lever body adjacent to the first bearing point; and wherein the hollow chamber structure is formed between the first and second bearing point.

2. The brake component according to claim 1, wherein the hollow chamber structure comprises a plurality of adjacent hollow chambers, and wherein at least one hollow chamber is designed as a recess and is open at at least one end to the environment, and wherein the hollow chambers of the hollow chamber structure are respectively surrounded by a wall.

3. The brake component according to claim 2, wherein at least one wall around a hollow chamber has a notch.

4. The brake component according to claim 1, wherein the hollow chamber structure is considerably longer in the transverse direction than in the longitudinal direction and/or along the pivot axis and wherein the hollow chamber structure extends over more than ⅔ of a width of the lever body.

5. The brake component according to claim 1, wherein the hollow chamber structure has a honeycomb structure and/or a lattice structure.

6. The brake component according to claim 1, wherein a maximum extension of a hollow chamber in a plane defined by the transverse direction and the longitudinal direction is smaller than ⅓ of a width of the lever body in the region of the hollow chamber structure.

7. The brake component according to claim 1, wherein at least one second hollow chamber structure is formed on the lever body and wherein the second hollow chamber structure is formed adjacent to the second bearing point and wherein the first hollow chamber structure and the second hollow chamber structure provide predetermined breaking points for different load cases.

8. The brake component according to claim 1, wherein the lever body has at least one pair of bearing points arranged one above the other in alignment along the pivot axis, to which a pair of hollow chamber structures is assigned.

9. The brake component according to claim 8, wherein the distal part of the brake lever runs in a fork-like manner in the direction of the proximal part of the brake lever and forms two fork branches running one above the other, on which the aligned bearing points and hollow chamber structures are formed and wherein a second pair of bearing points arranged one above the other in alignment is comprised on the two fork branches running one above the other.

10. The brake component according to claim 9, wherein the hollow chamber structure is formed as a predetermined breaking point between the first and second pair of bearing points.

11. The brake component according to claim 1, wherein predetermined breaking points are formed on various fork branches, such that injury to the user on a remainder of the lever element is prevented.

12. The brake component according to claim 1, wherein at least one lever element is produced by means of a 3D printing method such that the hollow chamber structure is printed by successive layer build-up, and wherein the lever element is formed integrally with a plastic material.

13. The brake component according to claim 12, wherein the plastic material is fibre-reinforced.

14. The brake component according to claim 1, wherein the lever element is formed at least in places with a metal or metal composite material.

15. The brake component according to claim 1, further including a brake unit such as a hydraulic brake cylinder, and wherein the brake lever is for a bicycle or motorcycle and is attached to the handlebar, and wherein the brake lever actuates a brake hydraulic system by means of rotation about at least one pivot axis of a bearing point.

16. A bicycle with a frame, at least two wheels and a handlebar and at least one brake component according to claim 1, wherein the brake lever is attached to the handlebar.

17. The bicycle according to claim 16, wherein the brake lever actuates a brake hydraulic system by means of rotation about at least one pivot axis of a bearing point.

18. A method for producing a brake lever of a brake component of a hand braking device with a lever element, comprising:
at least one bearing point is formed for providing a pivot axis; and wherein a hollow chamber structure is formed adjacent to the bearing point in order to provide a predetermined breaking point of the lever element in the region of the hollow chamber structure so that in the event of an impact, the lever element breaks at this predefined predetermined breaking point.

19. The method according to claim 18, wherein the brake lever is printed layer for layer by means of a 3D printing device, and
wherein in order to avoid airborne dust pollution caused by the printing medium during printing, for example a material in dust form, suction openings are formed in the brake lever itself during printing, through which the printing medium is sucked out such that dust pollution is minimised.

20. The method according to claim 18, wherein a plurality of adjacent grooves running around the pivot axis are formed at the bearing point in order to reduce weight and increase the tolerances for the installation of a bearing.
